(19) United States
(12) Patent Application Publication
(10) Pub. No.: US 2025/0102970 A1
(43) Pub. Date: Mar. 27, 2025

(54) FIXING DEVICE AND IMAGE FORMING APPARATUS

(71) Applicant: FUJIFILM Business Innovation Corp., Tokyo (JP)

(72) Inventors: Sou MORIZAKI, Kanagawa (JP); Hideki SATO, Kanagawa (JP)

(73) Assignee: FUJIFILM Business Innovation Corp., Tokyo (JP)

(21) Appl. No.: 18/434,298

(22) Filed: Feb. 6, 2024

(30) Foreign Application Priority Data
Sep. 21, 2023 (JP) 2023-154105

(51) Int. Cl. G03G 15/20; G03G 15/00

(52) U.S. Cl. CPC G03G 15/2025; G03G 15/6529; G03G 2215/2003

(57) ABSTRACT

A fixing device includes: a fixing unit that fixes an image on a medium; a guide unit that guides the medium, the guide unit being disposed downstream of the fixing unit in a transport direction of the medium; and a cleaner entrance portion through which a cleaning unit enters a gap between the fixing unit and the guide unit, the cleaner entrance portion being provided corresponding to the gap.

### CROSS-REFERENCE TO RELATED APPLICATIONS

This application is based on and claims priority under 35 USC 119 from Japanese Patent Application No. 2023-154105 filed Sep. 21, 2023.

### BACKGROUND

### (i) Technical Field

The present invention relates to a fixing device and an image forming apparatus including the fixing device.

### (ii) Related Art

Regarding a fixing device that fixes an image in an image recording device, techniques described in JP2014-59385A (Paragraphs [0039] to [0050], and FIGS. 7 to 10), JP2014-59391A (Paragraphs [0042] to [0054], and FIGS. 7 to 10), and JP2013-83969A (Paragraphs [0022] to [0027], and FIG. 4) are already known.

Described in JP2014-59385A (Paragraphs [0039] to [0050], and FIGS. 7 to 10), JP2014-59391A (Paragraphs [0042] to [0054], and FIGS. 7 to 10) are techniques of cleaning a fixing belt (171) or a heat roll (172) of a fixer by means of a first cleaning roll (210, 310). In JP2014-59385A (Paragraphs [0039] to [0050], and FIGS. 7 to 10), the first cleaning roll (210, 310) is formed in a roller-like shape extending along an axial direction of the fixing belt (171) or the heat roll (172).

Described in JP2013-83969A (Paragraphs [0022] to [0027], and FIG. 4) is a technique of wiping out unfixed toner adhering to a fixing belt (14) by means of an oil roller (13d) and removing, by means of a cleaning roller (13e), the unfixed toner wiped out by the oil roller (13d).

### SUMMARY

Aspects of non-limiting embodiments of the present disclosure relate to a fixing device and an image forming apparatus that can eliminate powder accumulating downstream of a fixing region.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a fixing device including: a fixing unit that fixes an image on a medium; a guide unit that guides the medium, the guide unit being disposed downstream of the fixing unit in a transport direction of the medium; and a cleaner entrance portion through which a cleaning unit enters a gap between the fixing unit and the guide unit, the cleaner entrance portion being provided corresponding to the gap.

### BRIEF DESCRIPTION OF THE DRAWINGS

Exemplary embodiment(s) of the present invention will be described in detail based on the following figures, wherein:

FIG. 1 is an overall explanatory view of an image forming apparatus of Example 1;

FIG. 2 is an explanatory view of a major portion of an image recording section of Example 1;

FIG. 3 is an enlarged view of a fixing device of Example 1;

FIG. 4 is a view as seen in a direction along an arrow IV in FIG. 3;

FIG. 5 is an explanatory view of a state where a protective portion is removed from FIG. 4; and

FIG. 6 is an explanatory view of a heating roller at the time of cleaning.

### DETAILED DESCRIPTION

Next, an example as a specific example of an exemplary embodiment of the present invention will be described with reference to the drawings. However, the present invention is not limited to an example as follows.

For the sake of easy understanding of the following description, in the drawings, a front-rear direction will be referred to as an X-axis direction, a right-left direction will be referred to as a Y-axis direction, and a vertical direction will be referred to as a Z-axis direction. Directions and sides represented by arrows X, −X, Y, −Y, Z, and −Z are a frontward direction, a rearward direction, a rightward direction, a leftward direction, an upward direction, a downward direction, a front side, a rear side, a right side, a left side, an upper side, and a lower side, respectively.

In addition, in the drawings, a circle with a point therein means an arrow from the back of the paper to the front of the paper and a circle with a cross therein means an arrow from the front of the paper to the back of the paper.

In the following description which will be made by using the drawings, members other than members necessary for the description are not shown as appropriate for the sake of easy understanding.

### EXAMPLE 1

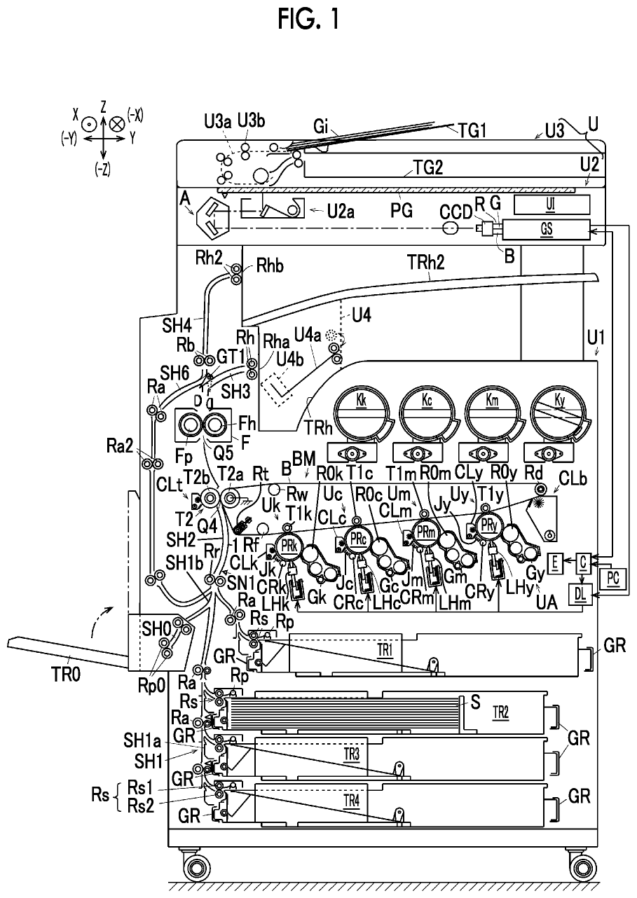

FIG. 1 is an overall explanatory view of an image forming apparatus of Example 1.

In FIG. 1, a copier U which is an example of the image forming apparatus of Example 1 of the present invention has a printer section U1, which is an example of image recording means and is an example of an image recording device. A scanner section U2, which is an example of reading means and is an example of an image reading device, is supported above the printer section U1. An autofeeder U3 which is an example of a document transporting device is supported above the scanner section U2.

A document tray TG1 which is an example of medium accommodating means is disposed above the autofeeder U3. A plurality of documents Gi to be copied can be stacked and accommodated in the document tray TG1. Below the document tray TG1, a document discharge tray TG2 which is an example of a document discharge portion is formed. Between the document tray TG1 and the document discharge tray TG2, document transport rollers U3b are disposed along a document transport path U3a.

Platen glass PG which is an example of a transparent document table is disposed on an upper surface of the scanner section U2. In the scanner section U2 of Example 1, a reading unit U2a which is an example of a reading section is disposed below the platen glass PG. The reading unit U2a of Example 1 is supported to be movable in a right-left direction, which is an example of a sub-scanning direction, along a lower surface of the platen glass PG. The reading unit U2a is electrically connected to an image processing unit GS.

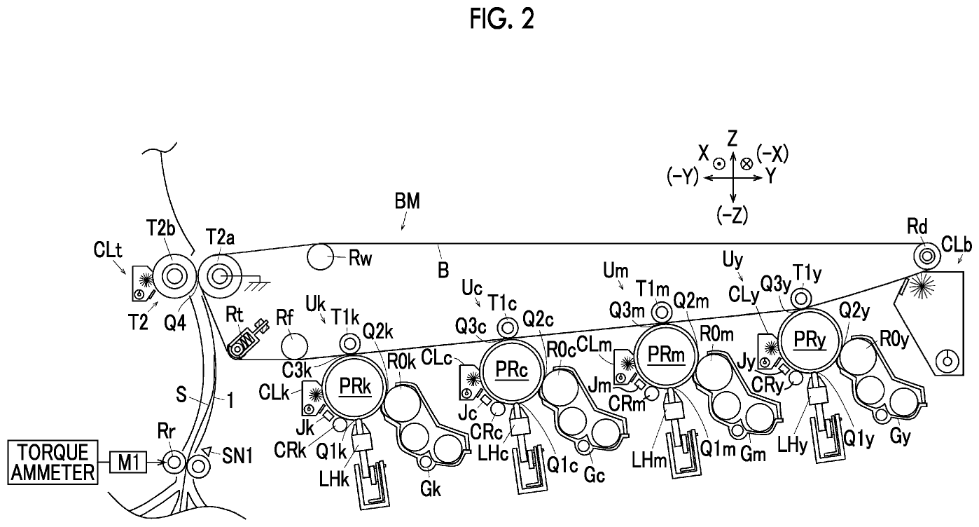

FIG. 2 is an explanatory view of a major portion of an image recording section of Example 1.

The image processing unit GS is electrically connected to a writing circuit DL of the printer section U1. The writing circuit DL is electrically connected to exposure devices LHy, LHm, LHc, and LHk each of which is an example of latent image forming means.

For example, each of the exposure devices LHy to LHk of Example 1 is composed of an LED head in which a plurality of LEDs are arranged in a main scanning direction. The exposure devices LHy to LHk are configured to output writing light beams corresponding to respective colors of Y, M, C, and K according to a signal input from the writing circuit DL.

In the writing circuit DL and a power supply circuit E, a writing timing and a power supply timing are controlled in accordance with a control signal from a control section C which is an example of control means.

In FIG. 1, photoreceptors PRy, PRm, PRc, and PRk each of which is an example of an image holding unit are disposed above the exposure devices LHy to LHk. In FIGS. 1 and 2, writing regions Q1y, Q1m, Q1c, and Q1k are composed of regions in which the photoreceptors PRy to PRk are irradiated with the writing light beams.

Charging rollers CRy, CRm, CRc, and CRk each of which is an example of charging means are disposed upstream of the writing regions Q1y to Q1k in respective rotation directions of the photoreceptors PRy to PRk. The charging rollers CRy to CRk of Example 1 come into contact with the photoreceptors PRy to PRk and are supported to be rotatable by being driven by the photoreceptors PRy to PRk.

Developing devices Gy, Gm, Gc, and Gk each of which is an example of developing means are disposed downstream of the writing regions Q1y to Q1k in the rotation directions of the photoreceptors PRy to PRk. Development regions Q2y, Q2m, Q2c, and Q2k are composed of regions in which the photoreceptors PRy to PRk and the developing devices Gy to Gk respectively face each other.

Primary transfer rollers T1y, T1m, T1c, and T1k each of which is an example of primary transfer means are disposed downstream of the developing devices Gy to Gk in the rotation directions of the photoreceptors PRy to PRk. Primary transfer regions Q3y, Q3m, Q3c, and Q3k are composed of regions in which the photoreceptors PRy to PRk and the primary transfer rollers T1y to T1k respectively face each other.

Photoreceptor cleaners CLy, CLm, CLc, and CLk each of which is an example of a cleaning unit are disposed downstream of the primary transfer rollers T1y to T1k in the rotation directions of the photoreceptors PRy to PRk.

Static eliminators Jy, Jm, Jc, and Jk, each of which is an example of a static elimination unit and each of which is an example of static elimination means, are disposed downstream of the photoreceptor cleaners CLy to CLk in the rotation directions of the photoreceptors PRy to PRk.

The Y-color photoreceptor PRy, the charging roller CRy, the exposure device LHy, the developing device Gy, the primary transfer roller T1y, the photoreceptor cleaner CLy, and the static eliminator Jy constitute a Y-color image forming unit Uy, which is an example of Y-color visible image forming means of Example 1 that forms a Y-color toner image. Similarly, the photoreceptors PRm, PRc, and PRk, the charging rollers CRm, CRc, and CRk, the exposure devices LHm, LHc, and LHk, the developing devices Gm, Gc, and Gk, the primary transfer rollers T1m, T1c, and T1k, the photoreceptor cleaners CLm, CLc, and CLk, and the static eliminators Jm, Jc, and Jk constitute M-color, C-color, and K-color image forming units Um, Uc, and Uk.

A belt module BM which is an example of an intermediate transfer device is disposed above the photoreceptors PRy to PRk. The belt module BM has an intermediate transfer belt B, which is an example of an image holding unit and is an example of intermediate transfer means. The intermediate transfer belt B is composed of an endless band-shaped member.

The intermediate transfer belt B of Example 1 is supported to be rotatable by a tension roller Rt which is an example of tensioning means, a walking roller Rw which is an example of deviation correction means, an idler roller Rf which is an example of driven means, a back-up roller T2a which is an example of means facing a secondary transfer region, the primary transfer rollers T1y to T1k, and a drive roller Rd each of which is an example of a drive member. In Example 1, the intermediate transfer belt B rotates in a case where a drive force is transmitted to the drive roller Rd.

A secondary transfer roller T2b which is an example of secondary transfer means is disposed at a position facing the back-up roller T2a with the intermediate transfer belt B interposed therebetween. The back-up roller T2a, the secondary transfer roller T2b, and the like constitute a secondary transfer device T2 of Example 1 which is an example of a transfer device. In addition, a secondary transfer region Q4 is composed of a region in which the secondary transfer roller T2b comes into contact with the intermediate transfer belt B.

A belt cleaner CLb which is an example of a cleaning device for an intermediate transfer body is disposed downstream of the secondary transfer region Q4 in a rotation direction of the intermediate transfer belt B.

A transfer device T1+T2+B of Example 1 which is an example of a transfer unit is composed of the primary transfer rollers T1y to T1k, the intermediate transfer belt B, the secondary transfer device T2, and the like. In addition, an image recording section Uy to Uk+T1+T2+B of Example 1 is composed of the image forming units Uy to Uk and the transfer device T1+T2+B.

In FIG. 1, pairs of right and left guide rails GR each of which is an example of a guide unit are provided in four stages below the image forming units Uy to Uk. The guide rails GR respectively support paper feed trays TR1, TR2, TR3, and TR4 each of which is an example of medium accommodating means such that the paper feed trays TR1, TR2, TR3, and TR4 can enter and exit in the front-rear direction. Recording sheets S each of which is an example of a medium are accommodated in the paper feed trays TRI to TR4.

A pick-up roller Rp which is an example of taking-out means is disposed on an upper left side of each of the paper feed trays TRI to TR4. A separating roller Rs which is an example of separating means is disposed downstream of the pick-up roller Rp in a transport direction of the recording sheet S. The separating roller Rs includes a feed roller Rs1 which is an example of a transporting unit and a retard roller Rs2 which is an example of stopping means. A paper feed path SH1 extending upward which is an example of a medium transport path is formed downstream of the separating roller Rs in the transport direction of the recording sheet S. A plurality of transport rollers Ra each of which is an example of a transporting unit are disposed on the paper feed path SH1.

A manual tray TR0 which is an example of medium accommodating means is disposed at a lower left portion of the copier U. A pick-up roller Rp0 is disposed at an upper right portion of the manual tray TR0, and a manual paper feed path SH0 extends at the upper right portion. The manual paper feed path SH0 joins the paper feed path SH1.

On the paper feed path SH1, a registration roller Rr which is an example of transport timing adjusting means is disposed upstream of the secondary transfer region Q4. A transport path SH2 extends from the registration roller Rr toward the secondary transfer region Q4.

A fixing device F which is an example of a fixing unit is disposed downstream of the secondary transfer region Q4 in the transport direction of the recording sheet S. The fixing device F has a heating roller Fh which is an example of a fixing member for heating and a pressing roller Fp which is an example of a fixing member for pressing. A fixing region Q5 is composed of a contact region between the heating roller Fh and the pressing roller Fp. A heater which is an example of a heat source is accommodated in the heating roller Fh. The pressing roller Fp is pressed against the heating roller Fh at a predetermined fixing pressure.

A lower paper discharge tray TRh which is an example of a medium discharge portion is formed on an upper surface of the printer section U1. Note that in Example 1, a finisher U4 which is an example of a post-processing device is installed at the lower paper discharge tray TRh. Above the fixing device F, a paper discharge path SH3 which is an example of a transport path extends toward the lower paper discharge tray TRh. A paper discharge roller Rh which is an example of a medium transporting unit is disposed at a downstream end of the paper discharge path SH3.

An upper paper discharge tray TRh2 which is an example of the medium discharge portion is disposed above the lower paper discharge tray TRh. An upper transport path SH4 that branches off from the paper discharge path SH3 and extends toward the upper paper discharge tray TRh2 is formed above the fixing device F.

On the upper transport path SH4, a reversing roller Rb that can rotate in forward and reverse directions and that is an example of the medium transporting unit is disposed. Above a bifurcation position between the paper discharge path SH3 and the upper transport path SH4, a reversing path SH6 which is an example of the medium transport path branches off from the upper transport path SH4 toward a lower left side.

A gate GT1 which is an example of switching means is disposed across a bifurcation portion between the paper discharge path SH3 and the upper transport path SH4 and a bifurcation portion between the upper transport path SH4 and the reversing path SH6. The gate GT1 guides the recording sheet S from the fixing device F toward the lower paper discharge tray TRh, and is supported to be switchable between a first guide position (second position) at which the recording sheet S is guided from the upper transport path SH4 to the reversing path SH6 and a second guide position (first position) at which the recording sheet S is guided from the fixing device F to the upper transport path SH4.

On the reversing path SH6, a plurality of the transport rollers Ra each of which is an example of the medium transporting unit are disposed. A downstream end of the reversing path SH6 joins the paper feed path SH1 upstream of the registration roller Rr.

### Description of Image Forming Operation

In the copier U of Example 1 having the above configuration, in a case where the document Gi is to be copied with the document Gi manually placed on the platen glass PG by a worker, the reading unit U2a moves in the right-left direction from an initial position and the document Gi on the platen glass PG is scanned while being exposed to light. In addition, in a case where the document Gi is to be copied with the document Gi automatically transported via the autofeeder U3, a plurality of the documents Gi accommodated in the document tray TG1 are sequentially transported to a document reading position on the platen glass PG, sequentially pass through the document reading position, and are discharged to the document discharge tray TG2. The documents Gi that sequentially pass through the reading position on the platen glass PG are exposed to light of the reading unit U2a and scanned. Reflected light from the document Gi is received by the reading unit U2a. The reading unit U2a converts the received reflected light from the document Gi into an electrical signal. Note that in a case where both sides of the document Gi are to be read, the document Gi is also read by a reading sensor.

The electrical signal output from the reading unit U2a is input to the image processing unit GS. The image processing unit GS converts electrical signals of R, G, and B color images read by the reading unit U2a into yellow (Y), magenta (M), cyan (C), and black (K) image information for formation of a latent image. The image processing unit GS outputs the converted image information to the writing circuit DL of the printer section U1. In a case where an image is a monochromatic image (so-called monochrome), the image processing unit GS outputs, to the writing circuit DL, image information of black K only.

The writing circuit DL outputs, to the exposure devices LHy to LHk, a control signal corresponding to the image information input thereto. The exposure devices LHy to LHk output writing light beams corresponding to the control signal.

Each of the photoreceptors PRy to PRk is rotationally driven as image formation is started. A charging voltage is applied to the charging rollers CRy to CRk from the power supply circuit E. Therefore, surfaces of the photoreceptors PRy to PRk are charged by the charging rollers CRy to CRk. Electrostatic latent images are formed on the surfaces of the charged photoreceptors PRy to PRk in the writing regions Q1y to Q1k by the exposure devices LHy to LHk. The electrostatic latent images of the photoreceptors PRy to PRk are developed into toner images each of which is an example of a visible image by the developing devices Gy to Gk in the development regions Q2y to Q2k.

The developed toner images are transported to the primary transfer regions Q3y to Q3k that come into contact with the intermediate transfer belt B which is an example of the intermediate transfer body. In the primary transfer regions Q3y to Q3k, a primary transfer voltage having a polarity opposite to the charging polarity of a toner is applied to the primary transfer rollers T1y to T1k from the power supply circuit E. Therefore, the respective toner images on the photoreceptors PRy to PRk are transferred to the intermediate transfer belt B by the primary transfer rollers T1y to T1k. In the case of multi-color toner images, a toner image on a downstream side is transferred to be superimposed on a toner image that is transferred to the intermediate transfer belt B in a primary transfer region on an upstream side.

Residues and adhering substances on the photoreceptors PRy to PRk after primary transfer are cleaned by the photoreceptor cleaners CLy to CLk. The surfaces of the photoreceptors PRy to PRk after cleaning are subjected to static elimination by the static eliminators Jy to Jk. The surfaces of the photoreceptors PRy to PRk after static elimination are re-charged by the charging rollers CRy to CRk.

Monochromatic or multi-color toner images transferred onto the intermediate transfer belt B by the primary transfer rollers T1y to T1k in the primary transfer regions Q3y to Q3k are transported to the secondary transfer region Q4.

The recording sheet S on which an image is to be recorded is taken out by the pick-up rollers Rp of the paper feed trays TR1 to TR4 to be used. In a case where a plurality of the recording sheets S are taken out in an overlapping manner, the recording sheets S taken out by the pick-up roller Rp are separated one by one by the separating roller Rs. That is, the uppermost recording sheet S is transported to the downstream side by the feed roller Rs1 while the recording sheets S overlapping each other are stopped by the retard roller Rs2, so that the recording sheets S are separated one by one. The recording sheet S separated by the separating roller Rs is transported to the paper feed path SH1 by the transport rollers Ra. The recording sheet S transported to the paper feed path SH1 is sent to the registration roller Rr. The recording sheet S loaded on the manual tray TR0 is also sent to the paper feed path SH1 through the manual paper feed path SH0 by the pick-up roller Rp0.

The registration roller Rr transports the recording sheet S to the secondary transfer region Q4 in accordance with a time at which the toner image formed on the intermediate transfer belt B is transported to the secondary transfer region Q4. A secondary transfer voltage having a polarity opposite to the charging polarity of the toner is applied to the secondary transfer roller T2b by the power supply circuit E. Therefore, the toner image on the intermediate transfer belt B is transferred from the intermediate transfer belt B to the recording sheet S.

After secondary transfer, adhering substances and the like adhering to a surface of the intermediate transfer belt B are cleaned by the belt cleaner CLb.

The recording sheet S onto which the toner image is secondarily transferred is heated for fixation in a case where the recording sheet S passes through the fixing region Q5.

In a case where post-processing is to be performed, the recording sheet S on which the image is fixed is transported to the finisher U4 which is an example of the post-processing device installed at the lower paper discharge tray TRh. In a case where the recording sheet S is not to be subjected to the post-processing, the recording sheet S is transported to the upper paper discharge tray TRh2. In a case where the recording sheet S is to be transported to the lower paper discharge tray TRh, the gate GT1 moves to the first guide position. Therefore, the recording sheet S sent out from the fixing device F is transported to the paper discharge path SH3. The recording sheet S transported to the paper discharge path SH3 is transported toward the finisher U4 and the lower paper discharge tray TRh by the paper discharge roller Rh.

The finisher U4 performs a binding process, which is an example of post-processing, with respect to the recording sheet S, and then discharges the recording sheet S to the lower paper discharge tray TRh.

In a case where the recording sheet S is to be discharged to the upper paper discharge tray TRh2, the gate GT1 moves to the second guide position so that the recording sheet S is discharged to the upper paper discharge tray TRh2.

In a case where the recording sheet S is to be subjected to two-sided printing, the gate GT1 moves to the second guide position. Then, in a case where a trailing end of the recording sheet S passes through the gate GT1, the gate GT1 moves to the first guide position and the reversing roller Rb rotates in a reverse direction. Therefore, the recording sheet S is guided by the gate GT1 to be sent to the reversing path SH6. The recording sheet S transported to the reversing path SH6 is sent to the registration roller Rr in a state where front and back sides are reversed.

### Explanation of Fixing Device

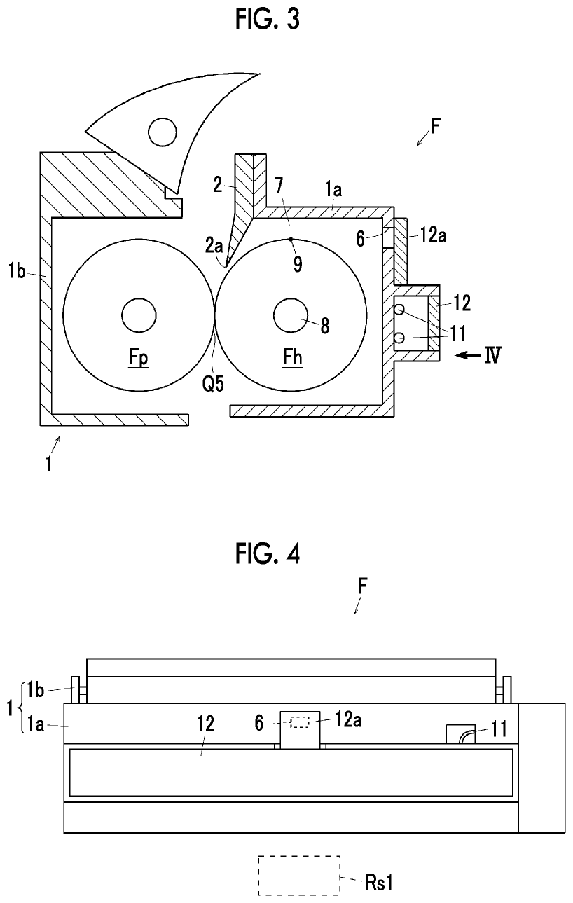

FIG. 3 is an enlarged view of the fixing device of Example 1.

FIG. 4 is a view as seen in a direction along an arrow IV in FIG. 3.

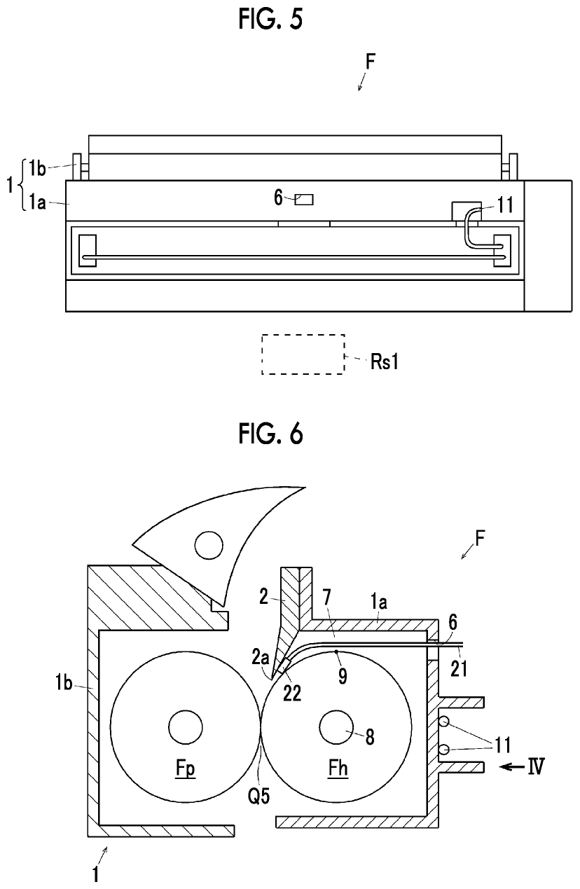

FIG. 5 is an explanatory view of a state where a protective portion is removed from FIG. 4.

In FIGS. 3 to 5, the fixing device F of Example 1 has a housing 1 which is an example of a housing. The housing 1 has a heating housing portion 1a surrounding the heating roller Fh and a pressing housing portion 1b surrounding the pressing roller Fp.

At the heating housing portion 1a, a downstream side sheet guide 2 which is an example of a guide unit is supported at a position that is downstream of the heating roller Fh in a paper transport direction. The downstream side sheet guide 2 comes into contact with the recording sheet S passing through the fixing region Q5 so as to guide the recording sheet S. A tip end portion 2a of the downstream side sheet guide 2 is disposed close to an outer surface of the heating roller Fh. Therefore, the downstream side sheet guide 2 of Example 1 also has a function as peeling means that peels the recording paper S off the heating roller Fh to restrain the recording sheet S from adhering to and being entangled in the heating roller Fh.

A cleaning hole 6 which is an example of a cleaner entrance portion is formed in the heating housing portion 1a. The cleaning hole 6 of Example 1 is formed at a position corresponding to a gap 7 between the outer surface of the heating roller Fh and the heating housing portion 1a. More specifically, the cleaning hole 6 is formed corresponding to the gap 7 that is downstream of a rotation center 8 of the heating roller Fh and that is downstream of a downstream-side apex 9 of the outer periphery of the heating roller Fh.

In FIG. 5, the cleaning hole 6 is formed at a position corresponding to the feed roller Rs1, which is an example of the transporting unit and an example of a paper feed unit, in an axial direction (longitudinal direction) of the heating roller Fh, that is, in a width direction of the recording sheet S.

In FIGS. 4 and 5, in the fixing device F of Example 1, a temperature sensor (not shown) that detects the temperature of the surface of the heating roller Fh is installed. Therefore, a harness 11, which is an example of a wire for power supply to the temperature sensor and signal transmission and reception, is routed. In addition, a harness cover 12 which is an example of a protective member is disposed outside the harness 11. The harness cover 12 is disposed such that the harness cover 12 covers the harness 11. Therefore, the harness cover 12 protects the harness 11.

At the harness cover 12 of Example 1, a cleaning protection portion 12a which is an example of a blocking portion is formed at a position corresponding to the cleaning hole 6. Therefore, an outer side of the cleaning hole 6 is blocked by the cleaning protection portion 12a. Therefore, the outer surface of the heating roller Fh is restrained from being exposed to the outside in comparison with a case where the cleaning hole 6 is not blocked. Therefore, the cleaning protection portion 12a protects the heating roller Fh.

The harness cover 12 is screwed to the heating housing portion 1a. It is possible to detach the harness cover 12 by loosening a screw in a case of performing a maintenance operation such as inspection and replacement of the harness 11 or a case of performing cleaning through the cleaning hole 6.

FIG. 6 is an explanatory view of the heating roller at the time of cleaning.

In FIG. 6, a cleaning rod 21 which is an example of a cleaning unit can be inserted into the cleaning hole 6 to perform cleaning. The cleaning rod 21 is composed of a flat plate-shaped rod extending in a longitudinal direction. The cleaning rod 21 may be configured to be flexible and it is preferable that the cleaning rod 21 is configured to be elastically deformable, for example. A felt 22 which is an example of a cleaning unit main body is disposed at a tip end portion of the cleaning rod 21. The felt 22 is formed of a cloth material. However, the present invention is not limited thereto. The cleaning unit main body may also be changed to a foam material, a rubber material, or the like.

Therefore, it is possible to clean the surface of the heating roller Fh with the felt 22 or clean a gap between the heating roller Fh and the tip end portion 2a of the downstream side sheet guide 2 by inserting the cleaning rod 21 into the cleaning hole 6. Here, the gap between the heating roller Fh and the tip end portion 2a of the downstream side sheet guide 2 is disposed below the apex 9 of the heating roller Fh. With regard to this, the cleaning rod 21 of Example 1 is configured to be elastically deformable and thus the felt 22 can enter the gap since a tip end portion of the cleaning rod 21 is bent downward in a case where the cleaning rod 21 is pushed inward.

In addition, in Example 1, it is possible to push dirt like paper dust accumulating in the gap or fillers such as calcium carbonate and talc out to the fixing region Q5 side by inserting the cleaning rod 21 and to collect, after cleaning is performed by the cleaning rod 21, the dirt pushed out to the fixing region Q5 side by transporting a test sheet and causing the dirt to adhere to the test sheet. The present invention is not limited thereto and it is also possible to attach an adsorbent material to the felt 22 and collect the dirt by adsorbing the dirt to the cleaning rod 21 side. Alternatively, a suction-type cleaner that sucks dirt together with air may also be used as a cleaning unit instead of the cleaning rod 21.

### Action of Example 1

In the copier U of Example 1 having the above configuration, the recording sheet S that has passed through the fixing device F is transported to the downstream side while coming into contact with the downstream side sheet guide 2. At this time, due to contact and friction between the recording sheet S and the downstream side sheet guide 2, powder like paper dust or fillers such as calcium carbonate is separated from the recording paper S. The separated powder floats and falls onto the surface of the heating roller Fh on a lower side. The powder that has fallen onto the heating roller Fh is likely to accumulate in a small-interval gap between the heating roller Fh and the downstream side sheet guide 2 as the heating roller Fh rotates. In a case where the powder accumulates over time, a fixation temperature may become locally insufficient, which causes a fixing failure, paper jam, damage to the heating roller Fh, or the like.

Accumulation of powder occurs not only in a case where the recording sheet S containing a large amount of paper dust or filler (white powder, calcium carbonate, or the like) is used and the present inventors have found, as a result of research, that accumulation of powder is likely to occur at a specific position in a sheet width direction. In the sheet width direction, the accumulation of powder is very likely to occur at the position of the feed roller Rs1. This is because, in a case where the recording sheet S in a stopped state is fed, a surface of the recording sheet S is scrubbed or crumpled due to rotation of the feed roller Rs1 while the recording sheet S is being pressed by being sandwiched between the feed roller Rs1 and the retard roller Rs2. Therefore, it is deduced that the accumulation is likely to occur downstream of the fixing region Q5 since the degree to which paper dust or fillers are bonded to the recording sheet S is lowered when the recording sheet S is fed by the feed roller Rs1 and the paper dust or the like is separated due to contact between the recording sheet S and the downstream side sheet guide 2.

In the case of a technique of performing cleaning by using a roller that comes into contact with the entire heating roller Fh as in the related art, it is difficult to cope with accumulation of powder at a specific position corresponding to the position of the feed roller Rs1 in a width direction. That is, in a case where a cleaning performance for the specific position is secured, a cleaning performance for most of the other region is excessive. In a case where the cleaning performance is excessive, there is a problem that the heating roller Fh is likely to be worn due to a cleaning roller pressed against or rubbing against the heating roller Fh, or the like. Meanwhile, in a case where the cleaning performance of the cleaning roller is set in accordance with a region other than the specific position, there is a problem that a cleaning performance for the specific position is insufficient.

With regard to this, in Example 1, the cleaning hole 6 is provided at a position corresponding to the feed roller Rs1 and it is possible to perform cleaning with the cleaning rod 21. Therefore, powder accumulating downstream of the fixing region Q5 may be eliminated.

### Modification Examples

Hereinabove, the example of the present invention has been described in detail. However, the present invention is not limited to the above example and various modifications can be made within the scope of the gist of the present invention described in the claims. Modification examples (H01) to (H05) of the present invention will be described below.
(H01) In the example, the copier U has been described as an example of the image forming apparatus. However, the present invention is not limited thereto, and the image forming apparatus can also be configured by using, for example, a printer, a fax machine, or a multifunction machine having a plurality of functions thereof or all of the functions thereof. In addition, the present invention is not limited to an electrophotographic image forming apparatus and the present invention can also be applied to any image forming apparatus such as an inkjet type image forming apparatus or a heat transfer printing type image forming apparatus.
(H02) In the example, the copier U having a configuration in which developing agents of four colors are used has been described. However, the present invention is not limited thereto and for example, the present invention can also be applied to a monochromatic image forming apparatus or a multicolor image forming apparatus in which three or less colors or five or more colors are used.
(H03) In the example, an endless band-shaped intermediate transfer belt B has been described as an example of the image holding unit. However, the present invention is not limited thereto. For example, the present invention can also be applied to a cylindrical intermediate transfer drum, a photoreceptor drum, and a photoreceptor belt. In addition, the present invention can also be applied to a configuration in which no intermediate transfer body is provided and an image from a photoreceptor is directly recorded on the recording sheet S.
(H04) In the example, a case where one cleaning hole 6 is provided in the width direction has been described. However, the present invention is not limited thereto. It is also possible to provide two or more cleaning holes 6 corresponding to positions where powder is likely to accumulate. Therefore, in a case where the powder is likely to accumulate at a position different from the position of the feed roller Rs1 in the width direction, the cleaning hole 6 may be provided at a position different from the position of the feed roller Rs1.
(H05) In the example, it is desirable that the cleaning protection portion 12a is provided at the harness cover 12, for example. However, the present invention is not limited thereto. It is also possible to provide the cleaning protection portion 12a separately from the harness cover 12. In addition, a configuration in which the cleaning protection portion 12a is not provided may also be adopted.

### Supplementary Note

(((1)))

A fixing device comprising:
a fixing unit that fixes an image on a medium;
a guide unit that guides the medium, the guide unit being disposed downstream of the fixing unit in a transport direction of the medium; and
a cleaner entrance portion through which a cleaning unit enters a gap between the fixing unit and the guide unit, the cleaner entrance portion being provided corresponding to the gap.
   (((2)))

The fixing device according to (((1))),
wherein the cleaner entrance portion that is provided at a position corresponding to a position of a transporting unit in a width direction of the medium is provided, the transporting unit being disposed upstream of the fixing unit in the transport direction of the medium, transporting the medium, and being disposed at a predetermined position in the width direction.
   (((3)))

The fixing device according to (((2))),
wherein the transporting unit that is composed of a paper feed unit feeding the medium is provided.
   (((4)))

The fixing device according to any one of (((1))) to (((3))),
wherein the cleaner entrance portion that is composed of an opening formed in a housing of the fixing unit is provided.
   (((5))

The fixing device according to (((4))),
wherein the housing in which a wire to the fixing unit is routed is provided, and
a protective portion that covers an outer side of the wire to protect the wire and that includes a blocking portion blocking the opening is provided.
   (((6)

An image forming apparatus comprising:
an image holding unit;
a transfer unit that transfers an image held by the image holding unit to a medium; and
the fixing device according to any one of (((1))) to (((5))), the fixing device fixing the image transferred to the medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device comprising:
a fixing unit that fixes an image on a medium;
a guide unit that guides the medium, the guide unit being disposed downstream of the fixing unit in a transport direction of the medium; and
a cleaner entrance portion through which a cleaning unit enters a gap between the fixing unit and the guide unit, the cleaner entrance portion being provided corresponding to the gap.

2. The fixing device according to claim 1,
wherein the cleaner entrance portion that is provided at a position corresponding to a position of a transporting unit in a width direction of the medium is provided, the transporting unit being disposed upstream of the fixing unit in the transport direction of the medium, transporting the medium, and being disposed at a predetermined position in the width direction.

3. The fixing device according to claim 2,
wherein the transporting unit that is composed of a paper feed unit feeding the medium is provided.

4. The fixing device according to claim 1,
wherein the cleaner entrance portion that is composed of an opening formed in a housing of the fixing unit is provided.

5. The fixing device according to claim 4,
wherein the housing in which a wire to the fixing unit is routed is provided, and
a protective portion that covers an outer side of the wire to protect the wire and that includes a blocking portion blocking the opening is provided.

6. An image forming apparatus comprising:
an image holding unit;
a transfer unit that transfers an image held by the image holding unit to a medium; and
the fixing device according to claim 1, the fixing device fixing the image transferred to the medium.

7. An image forming apparatus comprising:
an image holding unit;
a transfer unit that transfers an image held by the image holding unit to a medium; and
the fixing device according to claim 2, the fixing device fixing the image transferred to the medium.

8. An image forming apparatus comprising:
an image holding unit;
a transfer unit that transfers an image held by the image holding unit to a medium; and
the fixing device according to claim 3, the fixing device fixing the image transferred to the medium.

9. An image forming apparatus comprising:
an image holding unit;
a transfer unit that transfers an image held by the image holding unit to a medium; and
the fixing device according to claim 4, the fixing device fixing the image transferred to the medium.

10. An image forming apparatus comprising:
an image holding unit;
a transfer unit that transfers an image held by the image holding unit to a medium; and
the fixing device according to claim 5, the fixing device fixing the image transferred to the medium.

11. A fixing device comprising:
fixing means for fixing an image on a medium;
guiding means for guiding the medium, the guiding means being disposed downstream of the fixing means in a transport direction of the medium; and
cleaner entrance means through which cleaning means enters a gap between the fixing means and the guiding means, the cleaner entrance means being provided corresponding to the gap.
